(19) United States
(12) Patent Application Publication
(10) Pub. No.: US 2025/0289520 A1
(43) Pub. Date: Sep. 18, 2025

(54) METHOD AND DEVICE OF CONTROLLING MOTION OF ROBOT, ROBOT AND STORAGE MEDIUM

(71) Applicant: Beijing Youzhuju Network Technology Co., Ltd., Beijing (CN)

(72) Inventors: Jiafeng Xu, Beijing (CN); Guangzeng Chen, Beijing (CN); Tao Kong, Beijing (CN)

(21) Appl. No.: 19/033,415

(22) Filed: Jan. 21, 2025

(30) Foreign Application Priority Data
Mar. 18, 2024 (CN) 202410309674.3

(51) Int. Cl. B62D 57/028; B60G 17/0165; G06V 20/58

(52) U.S. Cl. CPC B62D 57/028; B60G 17/0165; G06V 20/58

(57) ABSTRACT

The present disclosure provides a method and a device of controlling motion of a robot, a robot and a storage medium, wherein the robot is a wheel-foot composite robot including at least one environmental sensing sensor, and the method includes: controlling the environment sensing sensor to acquire surrounding environmental information; determining a target motion mode of the wheel-foot composite robot based the surrounding environmental information; and controlling the motion of the wheel-foot composite robot based on the target motion mode.

### CROSS-REFERENCE

The present application claims priority to Chinese Patent Application No. 202410309674.3, filed on Mar. 18, 2024, and entitled “METHOD AND DEVICE OF CONTROLLING MOTION OF ROBOT, ROBOT AND STORAGE MEDIUM”, the disclosure of which is incorporated herein by reference in its entirety.

### FIELD

The embodiments of the present disclosure relate to the technical field of robots, in particular to a method and a device of controlling motion of a robot, a robot and a storage medium.

### BACKGROUND

At present, mobile robots include a wheeled robot and a foot type robot, wherein the motion of the wheeled robot is realized by controlling rollers disposed on a robot body to roll, and the motion of the foot type robot is realized by controlling leg mechanisms disposed on the robot body to walk alternately.

Although the moving speed of the wheeled robot is relatively fast, the wheeled robot is only applicable to a relatively even terrain environment and cannot be applied to an environment with a relatively complex terrain, and although the foot type robot has a low requirement on the environment and can be adapted to a relatively complex terrain environment, but the moving speed is slow.

### SUMMARY

Embodiments of the present disclosure provide a method and a device of controlling motion of a robot, a robot and a storage medium, the motion mode of the robot can be flexibly adjusted based on a motion environment, such that the robot can move not only in a relatively even terrain environment, but also in a relatively complex terrain environment, thereby improving the adaptability of the robot in different motion environments.

In a first aspect, an embodiment of the present disclosure provides a method of controlling motion of a robot, wherein the robot is a wheel-foot composite robot including at least one environmental sensing sensor, and the method includes:
controlling the environmental sensing sensor to acquire surrounding environmental information;
determining a target motion mode of the wheel-foot composite robot based on the surrounding environmental information; and
controlling the motion of the wheel-foot composite robot based on the target motion mode.

In a second aspect, an embodiment of the present disclosure provides a device of controlling motion of a robot, wherein the robot is a wheel-foot composite robot, and the wheel-foot composite robot includes at least one environmental sensing sensor, and the device includes:
an information acquiring module configured to control the environmental sensing sensor to acquire surrounding environmental information;
a mode determining module configured to determine a target motion mode of the wheel-foot composite robot based on the surrounding environmental information; and
a motion controlling module configured to control the motion of the wheel-foot composite robot based on the target motion mode.

In a third aspect, an embodiment of the present disclosure provides a robot, including:
at least one environmental sensing sensor configured to acquire surrounding environmental information of the robot;
a memory configured to store a computer program, and a processor configured to invoke and run the computer program stored in the memory, to execute the method of controlling motion of the robot according to the embodiment of the first aspect.

In a fourth aspect, an embodiment of the present disclosure provides a computer-readable storage medium configured to store a computer program, wherein the computer program causes a computer to execute the method of controlling motion of the robot according to the embodiment of the first aspect.

In a fifth aspect, an embodiment of the present disclosure provides a computer program product including program instructions, the program instructions, when running on a robot, causing the robot to execute the method of controlling motion of the robot according to the embodiment of the first aspect.

According to the technical solution disclosed by the embodiments of the present disclosure, the surrounding environmental information of the wheel-foot composite robot is acquired based on the environment sensing sensor, the target motion mode of the wheel-foot composite robot is determined based on the surrounding environmental information, and then the motion of the wheel-foot composite robot is controlled based on the target motion mode, so that the motion mode of the robot can be flexibly adjusted based on the motion environment, enabling the robot to move not only in a relatively even terrain environment, but also in a relatively complex terrain environment, thereby improving the adaptability of the robot in different motion environments.

### BRIEF DESCRIPTION OF DRAWINGS

In order to more clearly illustrate the technical solutions in the embodiments of the present disclosure, the accompanying drawings that need to be used in the description of the embodiments are briefly described below, and apparently, the drawings in the following description are merely some embodiments of the present disclosure, and for those of ordinary skill in the art, other drawings may be obtained based on these drawings without creative efforts.

FIG. 1 is a schematic structural diagram of a wheel-foot composite robot according to an embodiment of the present disclosure;

FIG. 2 is a flowchart of a method of controlling motion of a robot according to an embodiment of the present disclosure;

FIG. 3 is a flowchart of another method of controlling motion of robot according to an embodiment of the present disclosure;

FIG. 4 is a schematic block diagram of a device of controlling motion of a robot according to an embodiment of the present disclosure;

FIG. 5 is a schematic block diagram of a robot according to an embodiment of the present disclosure.

### DETAILED DESCRIPTION

The technical solutions in the embodiments of the present disclosure are clearly and completely described below with reference to the accompanying drawings in the embodiments of the present disclosure, and apparently, the described embodiments are only a part of the embodiments of the present disclosure and not all of them. According to the embodiments of the present disclosure, all other embodiments obtained by those skilled in the art without creative efforts shall fall within the scope of the present disclosure.

It should be noted that the terms “first”, “second”, and the like in the specification, claims and the foregoing drawings of the present disclosure are used to distinguish similar objects, and are not necessarily used to describe a specific order or sequence. It should be understood that such used data may be interchanged where appropriate so that embodiments of the present disclosure described herein can be implemented in an order other than those illustrated or described herein. Moreover, the terms “including” and “having” and any variations thereof are intended to cover a non-exclusive inclusion, e.g., a process, method, system, product, or server containing a series of steps or units not necessarily limited to those steps or units expressly listed, but may include other steps or units not expressly listed or inherent to such processes, methods, products, or devices.

In the embodiments of the present disclosure, words such as “example” or “for example” are used to indicate examples, illustrations, or descriptions, and any embodiment or solution described as “example” or “for example” in the embodiments of the present disclosure should not be construed as being more preferred or advantageous than other embodiments or solutions. Rather, words such as “example” or “for example” are intended to present related concepts in a specific manner.

In the description of the embodiments of the present disclosure, it should also be noted that, unless specified and defined otherwise, the terms “dispose”, “arrange”, “connect”, and “couple” should be understood in a broad sense, for example, may be fixedly connected, or may be detachably connected, or integrally connected; may be a mechanical connection, or may be an electrical connection; or may be a direct connection, or may be indirectly connected through an intermediate medium, and may be a connection within two elements or an interaction relationship between two elements. For those skilled in the art, the specific meaning of the above terms in the present disclosure can be understood in combination with the prior art according to specific conditions. In addition, in a case of no conflict, the features in the embodiments of the present disclosure may be combined with each other. And one or more of the components in the drawings may be necessary or not necessary, and the relative positional relationship between the various components illustrated above may be adjusted as desired.

In the description of the embodiments of the present disclosure, unless otherwise specified, “a plurality of” refer to two or more, that is, at least two. “At least one” means one or more.

Currently, the mobile robot includes a wheeled robot and a foot type robot, wherein although the moving speed of the wheeled robot is relatively fast, the wheeled robot is only applicable to a relatively even terrain environment and cannot be applied to a relatively complex terrain environment, and although the foot type robot has a low environment requirement and can be adapted to a relatively complex terrain environment, the moving speed is slow, so that the mobile robot cannot be adapted to complex and diverse motion environments.

In order to solve the above technical problem, a concept of the present disclosure is to obtain a robot with a wheel-foot composite structure, that is, a wheel-foot composite robot, by combining the efficient motion characteristics of the wheeled robot on the even terrain with the high adaptation characteristics of the foot type robot on the complex terrain, so that the wheel-foot composite robot can dynamically adjust the motion mode thereof in the motion process based on the surrounding environmental information acquired by the environmental sensing sensor, enabling the robot to move not only in a relatively even terrain environment, but also in a relatively complex terrain environment, thereby improving the adaptability of the robot in different motion environments.

The technical solutions of the present disclosure are described in detail below with some embodiments. The embodiments described below may be combined with each other, and the same or similar concepts or processes may not be repeated in certain embodiments.

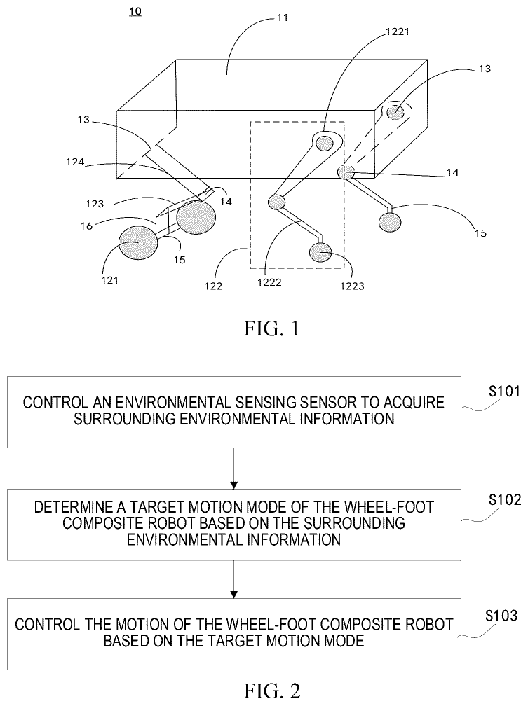

First, a structure of a wheel-foot composite robot in an embodiment of the present disclosure is specifically described. As shown in FIG. 1, the wheel-foot composite robot 10 includes a robot body 11 and four motion mechanisms disposed on the robot body 11, wherein the four motion mechanisms include two rear rollers 121 and two front leg mechanisms 122.

In the present disclosure, the two front leg mechanisms 122 include a left front leg mechanism and a right front leg mechanism. Each of the front leg mechanisms 122 includes a front thigh mechanism 1221, a front shank mechanism 1222, and a roller 1223 disposed at an end of each front shank mechanism. The roller 1223 on the end of the front shank mechanism may be understood as a driven roller. In FIG. 1, a connecting portion between the front thigh mechanism 1221 and the robot body 11 includes a hip joint 13, a connecting portion between the front thigh mechanism 1221 and the front shank mechanism 1222 includes a knee joint 14, and a connecting portion between the front shank mechanism 1222 and the roller 1223 includes an ankle joint 15.

In some optional embodiments, the two rear rollers 121 are disposed at two ends of a rotatable connecting component 16, a rotatable end of the connecting component 16 is connected to an end of a rear shank mechanism 123, the other end of the rear shank mechanism 123 is connected to an end of a rear thigh mechanism 124, and the other end of the rear thigh mechanism 124 is connected to the robot body 11. The two rear rollers 121 may be understood as driving rollers.

That is, the motion mechanisms disposed on the robot body 11 in the present disclosure include a rear leg mechanism, wherein the rear leg mechanism includes the rear thigh mechanism 124, the rear shank mechanism 123, the connecting component 16, and two rear rollers 121 disposed at two ends of the connecting component 16. In the present disclosure, a connecting portion between the rear thigh mechanism 124 and the robot body 11 include a hip joint 13, a connecting portion between the rear thigh mechanism 124 and the rear shank mechanism 123 includes a knee joint 14, a connecting portion between the rear shank mechanism 124 and each rear roller 121 includes an ankle joint 15. That is, the leg mechanism of the present disclosure includes one hip joint 13, one knee joint 14, and two ankle joints 15.

In addition, the hip joint 13, the knee joint 14, and the ankle joint 15 are correspondingly provided with motors, specifically, a hip joint motor, a knee joint motor and an ankle joint motor, by corresponding torque output from the hip joint motor, the knee joint motor and/or the ankle joint motor driving the hip joint 13, the knee joint 14 and/or the ankle joint 15 to change, realizing the purpose of motion mode switching of the wheel-foot composite robot.

Each joint above may be understood as indicating that at least two components of the wheel-foot composite robot are movably connected. Moreover, each joint can move under the control of torque output from the joint motor. For example, a certain joint can rotate by an angle, causing other joints and related mechanisms to generate a certain amount of movement in the space, thereby realizing a change of the motion mode of the wheel-foot composite robot.

Further, in order to detect different motion environments and whether there is an obstacle in the motion environments, at least one environmental sensing sensor may be disposed at the front end of the robot body 11 of the wheel-foot composite robot 10, and at least one environmental sensing sensor may be disposed at the rear end of the robot body 11, so that the wheel-foot composite robot may realize functions such as autonomous obstacle avoidance and map building navigation based on the environment sensing sensors.

The environmental sensing sensors may include, but are not limited to, a laser sensor, a vision sensor, an infrared sensor, an ultrasonic sensor, and a laser radar sensor.

As an optional implementation, a vision sensor may be disposed at an intermediate position of a front end of the robot body 11 shown in FIG. 1, a laser radar sensor is respectively disposed on the left and right sides relative to the middle of the robot body 11, a laser sensor is disposed at an intermediate position of a rear end of the robot body 11, and an ultrasonic sensor (not shown) is respectively disposed on the left and right sides relative to the middle of the robot body 11.

It should be noted that the number, the position, and the type of the environmental sensing sensors disposed on the robot body 11 shown in FIG. 1 are merely illustrative, and may be flexibly adjusted based on actual application requirements, which is not limited in the present disclosure.

After the structure of the wheel-foot composite robot is described, a method and a device of controlling motion of a robot, a robot and a storage medium provided in the embodiments of the present disclosure are specifically described below. The robot is the wheel-foot composite robot described above.

FIG. 2 is a flowchart of a method of controlling motion of a robot according to an embodiment of the present disclosure. The method of controlling motion of the robot provided in the embodiments of the present disclosure may be executed by a device of controlling motion of a robot, and the device may be composed of hardware and/or software, and may be integrated into the wheel-foot composite robot described above.

As shown in FIG. 2, the method may include the following steps:

S101, controlling an environmental sensing sensor to acquire surrounding environmental information.

Optionally, when the wheel-foot composite robot executes any working task triggered by a user, a controller in the wheel-foot composite robot may control the environmental sensing sensor to collect the surrounding environmental information in real time, to determine whether there is an obstacle in a motion path of the wheel-foot composite robot and a motion road surface condition based on the surrounding environmental information collected by the environmental sensing sensor. When determining whether there is an obstacle in the motion path of the wheel-foot composite robot, in accordance with a determination that there is an obstacle, information such as the size, shape, and position of the obstacle may be then determined. In the present disclosure, the above motion road surface condition may be a relatively even road surface or an uneven road surface, which is not limited in the present disclosure.

In some optional embodiments, after acquiring the surrounding environmental information, the environmental sensing sensor may further send the surrounding environmental information to the controller in real time, the controller performs fusion processing on the surrounding environmental information acquired by each environmental sensing sensor based on the environment sensing algorithm, obtaining an environmental parameter of whether there is an obstacle in the motion path of the wheel-foot composite robot and the motion road surface condition, thereby improving the sensing accuracy of the motion environment of the wheel-foot composite robot.

S102, determining a target motion mode of the wheel-foot composite robot based on the surrounding environmental information.

S103, controlling the motion of the wheel-foot composite robot based on the target motion mode.

Based on the structure of the wheel-foot composite robot shown in FIG. 1, it should be understood that the target motion mode of the wheel-foot composite robot in the present disclosure includes one of a wheeled motion mode and a wheel-foot composite motion mode.

The wheeled motion mode can be understood as a pure wheeled motion, and the wheel-foot composite motion mode can be understood as a motion mode of a mixing of wheeled motion and foot type motion.

It should be understood that the above motion mode refers to a motion mode of the wheel-foot composite robot.

In some optional embodiments, the present disclosure may first obtain a motion direction (that is, a moving direction) of the wheel-foot composite robot, and further based on the motion direction and surrounding environmental information acquired by the environmental sensing sensor, determine an intended motion region to which the wheel-foot composite robot is about to cross and the state information of the intended motion region (that is, the state of the intended motion region). Then, a target motion mode of the wheel-foot composite robot is determined based on the state information of the intended motion region.

The state information of the intended motion region may be that the intended motion region is even terrain and free of obstacles, or the intended motion region is uneven terrain, or there is an obstacle in the intended motion region, or the intended motion region is uneven terrain and presence of an obstacle.

Considering that the wheeled motion mode may be adapted to even terrain and free of obstacles environment to provide stable and efficient translational motion, while the wheel-foot composite motion mode may be adapted to complex terrain environment (i.e., uneven terrain and/or presence of an obstacle) such that the wheel-foot composite robot may move smoothly in complex terrain environment. Therefore, in the present disclosure, when it is determined that the state of the intended motion region is even terrain region and free of obstacles, the wheeled motion mode may be determined as the target motion mode of the wheel-foot composite robot. When it is determined that the state of the intended motion region is uneven terrain and/or presence of an obstacle, the wheel-foot composite motion mode may be determined as the target motion mode of the wheel-foot composite robot.

Further, the controller controls the motion of the wheel-foot composite robot based on the determined target motion mode.

In some optional embodiments, for controlling the motion of the wheel-foot composite robot, optionally, the controller determines whether the current motion mode and the target motion mode of the wheel-foot composite robot are the same, and in accordance with a determination that they are the same, based on the current motion mode, controls the wheel-foot composite robot to continue to move along the motion path pre-planned based on the work task. In accordance with a determination that they are not the same, it indicates that the current motion mode of the wheel-foot composite robot does not meet the motion requirement, at this time, the current motion mode of the wheel-foot composite robot is adjusted to the target motion mode, so that the wheel-foot composite robot moves along the motion path pre-planned based on the work task based on the target motion mode. Therefore, the wheel-foot composite robot can combine the advantage of efficient movement of the wheeled robot in the even terrain environment with the advantage of obstacle avoidance, motion balance and the stability of the foot type robot in the complex terrain environment, so that good motion performance of the wheel-foot composite robot can be ensured under various motion environments.

According to the technical solutions disclosed by the embodiment of the present disclosure, the surrounding environmental information of the wheel-foot composite robot is acquired based on the environment sensing sensor, the target motion mode of the wheel-foot composite robot is determined based on the surrounding environmental information, and then the motion of the wheel-foot composite robot is controlled based on the target motion mode, so that the motion mode of the robot can be flexibly adjusted based on the motion environment, enabling the robot to move not only in a relatively even terrain environment, but also in a relatively complex terrain environment, thereby improving the adaptability of the robot in different motion environments.

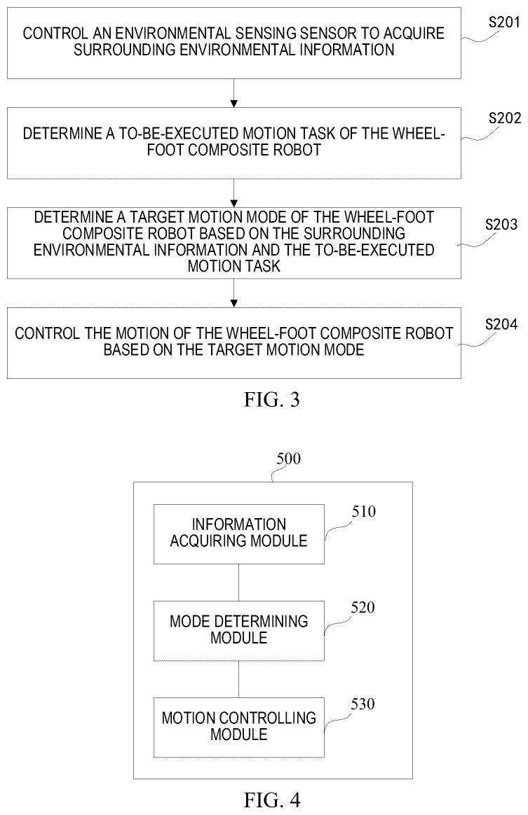

In some optional realization scenarios, considering that four motion mechanisms of the wheel-foot composite robot include two rear rollers and two front leg mechanisms. The rear rollers are always in a wheeled motion mode, and the front leg mechanisms may include a wheeled motion mode and a foot type motion mode. Therefore, the wheel-foot composite motion mode corresponding to the wheel-foot composite robot in the present disclosure can include three modes: a first wheel-foot composite motion mode is obtained based on wheeled motion modes of the two rear rollers, a foot type motion mode of the left front leg mechanism, and a wheeled motion mode of the right front leg mechanism; a second wheel-foot composite motion mode is obtained based on the wheeled motion modes of the two rear rollers, a wheeled motion mode of the left front leg mechanism, and a foot type motion mode of the right front leg mechanism; and a third wheel-foot composite motion mode is obtained based on the wheeled motion modes of the two rear rollers, and the foot type motion modes of the two front leg mechanisms. Then, the method of controlling motion of the robot disclosed in the embodiments of the present disclosure is further explained and illustrated based on the above three wheel-foot composite motion modes, as shown in FIG. 3.

As shown in FIG. 3, the method may include the following steps:
S201, controlling an environmental sensing sensor to acquire surrounding environmental information.
S202, determining a to-be-executed motion task of the wheel-foot composite robot.
S203, determining a target motion mode of the wheel-foot composite robot based on the surrounding environmental information and the to-be-executed motion task.
S204: controlling the motion of the wheel-foot composite robot based on the target motion mode.

Considering that the wheel-foot composite robot executes a certain work task, the work task may be implemented by executing a plurality of motion tasks. That is, in a case of one work task corresponding to a plurality of motion tasks, the wheel-foot composite robot executes the work task by executing each motion task in sequence based on the execution sequence of the plurality of motion tasks until the work task is completed.

Therefore, the to-be-executed motion task optionally is a certain motion task to be executed in a plurality of motion tasks corresponding to a certain work task.

In the present disclosure, the plurality of motion tasks corresponding to a certain work task may be input by a user, or may be generated by the wheel-foot composite robot using a task planning algorithm based on the work task, which is not limited in the present disclosure.

In some optional embodiments, after acquiring the surrounding environmental information of the wheel-foot composite robot, the present disclosure may further acquire a next to-be-executed motion task based on the currently executed motion task of the wheel-foot composite robot. Then, the target motion mode of the wheel-foot composite robot is determined jointly based on the surrounding environment and the to-be-executed motion task, whereby by controlling the motion of the wheel-foot composite robot based on the motion environment and the motion task, the wheel-foot composite robot can flexibly switch the motion mode based on different motion environments and motion task requirements, so as to improve the motion flexibility and adaptability of the wheel-foot composite robot.

As an optional implementation, the determining a target motion mode of the wheel-foot composite robot may include the following steps:
Step S1, determining an intended motion region of the wheel-foot composite robot and a state of the intended motion region based on the motion direction and the surrounding environmental information of the wheel-foot composite robot.
Step S2, determining a target motion state of the wheel-foot composite robot based on the state of the intended motion region and the type of the to-be-executed motion task.

In some optional embodiments, the target motion state of the wheel-foot composite robot may include one of the following:

First, in response to determining that the state of the intended motion region of the wheel-foot composite robot is even terrain and free of obstacles based on the surrounding environmental information, and the to-be-executed motion task being a motion task, determining that the target motion mode of the wheel-foot composite robot is a wheeled motion mode.

The motion task may optionally include one of a forward task, a backward task, or a steering task. The steering task in the present disclosure may be understood as a left steering task or a right steering task.

Considering that the wheeled motion mode can realize rapid passage through even terrain and free-of-obstacles areas, when it is determined that the state of the intended motion region of the wheel-foot composite robot is even terrain and free of obstacles, and the to-be-executed motion task is a motion task, the controller can secure each joint of the left and right front leg mechanisms of the wheel-foot composite robot at a corresponding position based on the to-be-executed motion task in the present disclosure, so that the two front leg mechanisms are in a wheeled motion mode, thereby obtaining an overall motion mode of the wheel-foot composite robot based on the wheeled motion mode of the front leg mechanisms and the wheeled motion mode of the rear rollers, and the overall motion mode is a wheeled motion mode.

As an optional implementation, according to the to-be-executed motion task, each joint of the left and right front leg mechanisms of the wheel-foot composite robot is secured at the corresponding position, which may be implemented by a joint torque control algorithm, wherein the joint torque control algorithm may be as following formula (1):

$${τ}_{i} = {kp}_{i} ( {p}_{{i}_{des}} - {p}_{{i}_{act}} ) + {kd}_{i} ( {v}_{{i}_{des}} - {v}_{{i}_{act}} ) \qquad ( 1 )$$

Wherein, τᵢ is a fixing position of the i-th joint of the left and right front leg mechanisms, kpᵢ is a position control gain of the i-th joint, pᵢ_{_{des}} is a desired position of the i-th joint, pᵢ_{_{act}} is a actual position of the i-th joint, kdᵢ is a speed control gain of the i-th joint, vᵢ_{_{des}} is a desired speed of the i-th joint, and vᵢ_{_{act}} is an actual speed of the i-th joint.

In addition, the position control gain kpᵢ of the i-th joint, and the speed control gain kdᵢ of the i-th joint are both adjustable parameters, which may be flexibly set based on actual application requirements, which is not limited in the present disclosure.

Since each joint of the two front leg mechanisms is secured at the corresponding position, the desired speed of the joint is 0. Based on this, in the present disclosure, the above formula (1) may be deformed to obtain the following formula (2):

$$\begin{matrix}{τ}_{i} = {kp}_{i} ( {p}_{{i}_{des}} - {p}_{{i}_{act}} ) + {kd}_{i} ( 0 - {v}_{{i}_{act}} ) \\ = {kp}_{i} ( {p}_{{i}_{des}} - {p}_{{i}_{act}} ) - {kd}_{i} ( {v}_{{i}_{act}} )\end{matrix} \qquad ( 2 )$$

Because the actual speed of each joint of the two front leg mechanisms can be calculated based on the actual position of the joint, the above formula (2) can be deformed to obtain the following formula (3):

$${τ}_{i} = {kp}_{i} ( {p}_{{i}_{des}} - {p}_{{i}_{act}} ) - {kd}_{i} {\dot{p}}_{{i}_{act}} \qquad ( 3 )$$

\dot{P}ᵢ_{_{act}} is the actual speed of the i-th joint, which is obtained by performing differential operation on the actual position \dot{P}ᵢ_{_{act}} of the i-th joint.

Based on the foregoing FIG. 1, it can be learned that the two front leg mechanisms of the wheel-foot composite robot include a hip joint, a knee joint, and an ankle joint, respectively, and then identification information may be set for the six joints, so that identity information of the joints may be determined based on the identification information. As an optional implementation in the present disclosure, the following identification information may be set for joint of each of the left and right front leg mechanisms in a sequence of the right front leg mechanism after the left front leg mechanism: a left hip joint 1, a left knee joint 2, a left ankle joint 3, a right hip joint 4, a right knee joint 5, and a right ankle joint 6; or, the following identification information may be set for joint of each of the left and right front leg mechanisms in a sequence of the left front leg structure after the right front leg mechanism: the right hip joint 1, the right knee joint 2, the right ankle joint 3, the left hip joint 4, the left knee joint 5, and the left ankle joint 6, which are not limited in the present disclosure. That is, the above i ∈=[1,6].

In addition, the desired position pᵢ_{_{des}} of the i-th joint may be calculated based on the actual position pᵢ_{_{act}} of the i-th joint by using an inverse kinematics algorithm or the like, and the specific algorithm for calculating the desired position based on the actual position is not limited in the present disclosure.

It should be understood that the inverse kinematics calculate a desired position of the i-th joint based on the actual position of the i-th joint pᵢ_{_{act}}, specifically, calculate a desired angle of the i-th joint, and determine the desired angle as the desired position of the i-th joint.

The actual position pᵢ_{_{act}} of the i-th joint may be understood as a target three-dimensional position in the real physical space input when executing the motion task. In addition, the actual position pᵢ_{_{act}} of the i-th joint may be obtained by reading from a joint encoder corresponding to the i-th joint.

It should be noted that, usually the joint angle is stored in the joint encoder, so the actual position read from the joint encoder in the present disclosure is specifically an actual joint angle.

In the embodiment of the present disclosure, when the target motion mode is a wheeled motion mode, the control manner of the two rear rollers of the wheel-foot composite robot in the wheeled motion mode is a differential wheel system, so as to realize the wheel-foot composite robot to execute the forward task, the backward task and the left and right steering tasks by controlling the speeds of the left and right rear rollers.

For example, assuming that the speed of the left rear roller is controlled to be greater than the speed of the right rear roller, the wheel-foot composite robot executes the right steering task. For another example, assuming that the left rear roller and the right rear roller are controlled to rotate forward at the same speed, the wheel-foot composite robot executes the forward task. For another example, assuming that the left rear roller and the right rear roller are controlled to rotate backwards at the same speed, the wheel-foot composite robot executes the backward task.

Second, in response to determining that the state of the intended motion region of the wheel-foot composite robot is uneven terrain and/or presence of an obstacle based on the surrounding environmental information, and the to-be-executed motion task being a motion task, determining that the target motion mode of the wheel-foot composite robot is the first wheel-foot composite motion mode, the second wheel-foot composite motion mode, or the third wheel-foot composite motion mode.

Considering that the complex terrain region may be an uneven terrain region and/or presence of an obstacle, the uneven terrain position and/or the obstacle position may be located in a certain orientation in the intended motion region. Therefore, in the present disclosure, based on the orientation of the uneven terrain position and/or the obstacle position in the intended motion region, the target motion mode of the wheel-foot composite robot can be determined from the first wheel-foot composite motion mode, the second wheel-foot composite motion mode or the third wheel-foot composite motion mode. Furthermore, by utilizing the target motion mode, a rolling motion of the wheel-foot composite robot can be driven through the wheeled motion, the motion environment of complex terrain is adapted through foot type motion, the wheel-foot composite robot can be ensured to avoid obstacles in the efficient motion process, thereby improving the motion stability and balance of the wheel-foot composite robot.

In some optional embodiments, when the orientation of the uneven terrain position and/or the obstacle position in the intended motion region is biased toward the orientation where the left front leg mechanism of the wheel-foot composite robot is located, in order to smoothly cross the uneven terrain position and/or avoid the obstacle, in the present disclosure, it may be determined that the target motion mode of the wheel-foot composite robot is the first wheel-foot composite motion mode. That is, when it is determined that the terrain in front of the left side of the wheel-foot composite robot is uneven and/or presence of an obstacle, the left front leg mechanism of the wheel-foot composite robot is controlled to be in a foot type motion, and the remaining three motion mechanisms are in a wheeled motion, so that the wheel-foot composite robot crosses the obstacle based on the left front leg mechanism in the foot type motion, thereby improving the obstacle crossing ability of the wheel-foot composite robot while the wheel-foot composite robot efficiently crosses the intended motion region.

When the orientation of the uneven terrain position and/or the obstacle position in the intended motion region is biased toward the orientation where the right front leg mechanism of the wheel-foot composite robot is located, in the present disclosure, it may be determined that the target motion mode of the wheel-foot composite robot is the second wheel-foot composite motion mode. That is, when it is determined that the terrain in front of the right side of the wheel-foot composite robot is uneven and/or presence of an obstacle, the right front leg mechanism of the wheel-foot composite robot is controlled to be in a foot type motion, and the remaining three motion mechanisms are in a wheeled motion, so that the wheel-foot composite robot can cross the obstacle based on the right front leg mechanism in the foot type motion.

When the orientation of the uneven terrain position and/or the obstacle position in the intended motion region is located at the orientations where the left and right front leg mechanisms of the wheel-foot composite robot are located, it is determined that the target motion mode of the wheel-foot composite robot is the third wheel-foot composite motion mode. That is, when it is determined that the terrain in front of the left and right sides of the wheel-foot composite robot is uneven and/or presence of an obstacle, the left and right front leg mechanisms of the wheel-foot composite robot are controlled to be in a foot type motion, and the remaining two motion mechanisms are in a wheeled motion, so that the wheel-foot composite robot crosses the obstacle based on the left and right front leg mechanisms in the foot type motion.

In the present disclosure, the motors provided at the ankle joints of the left and right front leg mechanisms of the wheel-foot composite robot may be linear motors. When it is necessary to control the motion mode of any of front leg mechanisms to be switched from the wheeled motion mode to the foot type motion mode, the driven roller in the front leg mechanism can be locked through the linear motor, so that the driven roller in the front leg mechanism becomes a foot in contact with the ground in the front leg mechanism. In contrast, when it is necessary to control the motion mode of any of front leg mechanisms to be switched from the foot type motion mode to the wheeled motion mode, the locked driven roller can be unlocked through the linear motor, so that the foot in contact with the ground in the front leg mechanism becomes the driven roller.

Third, in response to determining that the state of the intended motion region of the wheel-foot composite robot is even terrain and free of obstacles, or uneven terrain and/or presence of an obstacle based on the surrounding environmental information, and the to-be-executed motion task being an interactive task, determining that the target motion mode of the wheel-foot composite robot is the third wheel-foot composite motion mode.

The interactive task may be understood as a task of interacting with an object or a person. For example, controlling the wheel-foot composite robot to press an elevator button, or interact with a person by shaking hands.

In some optional embodiments, when it is determined that the to-be-executed motion task of the wheel-foot composite robot is an interactive task, either of the front leg mechanisms of the wheel-foot composite robot should be in a lifted state, and the remaining one front leg mechanism and the two rear rollers are respectively in contact with the ground to be in a support state. Therefore, in order to enable the wheel-foot composite robot to keep itself in a static balance state when executing the interactive task based on the front leg mechanism in the lifted state, in the present disclosure, it is realized by controlling a centroid projection position of the wheel-foot composite robot within a support polygonal region formed by support points formed by a support leg and the two rear roller. The centroid projection position may be understood as a projection position when the centroid is projected to a plane where the support polygon region is located.

Considering that the positions of the support points of the two rear roller are known, in order to enable the centroid projection position of the wheel-foot composite robot to be located within the support polygonal region formed by the support points of the support leg and the two rear roller, in the present disclosure, it is necessary to control the position of the landing point of the support leg. As an optional implementation, two constraint conditions may be set for the position of the landing point of the support leg, the first constraint condition is to control the centroid projection position of the wheel-foot composite robot to be located in the support polygonal region formed by the support points of the support leg and the two rear roller, the second constraint condition is that the position of the landing point of the support leg needs to be located in the combined region of physical limit position where the support leg corresponds to each joint. The physical limit position where the support leg corresponds to each joint is set based on the physical structure of the wheel-foot composite robot, which is not limited in the present disclosure.

Further, the controller in the wheel-foot composite robot can calculate the landing position of the support leg based on the two constraint conditions, enabling the centroid projection position of the wheel-foot composite robot to be located within the support polygonal region formed by the support points of the support leg and the two rear rollers.

In some optional embodiments, after determining the target motion mode of the wheel-foot composite robot, in the present disclosure, the wheel-foot composite robot may be controlled to move based on the target motion mode, to execute a corresponding work task.

According to the technical solution disclosed by the embodiment of the present disclosure, the surrounding environmental information of the wheel-foot composite robot is acquired based on the environment sensing sensor, the target motion mode of the wheel-foot composite robot is determined based on the surrounding environmental information, and then the motion of the wheel-foot composite robot is controlled based on the target motion mode, so that the motion mode of the robot can be flexibly adjusted based on the motion environment, enabling the robot to move not only in a relatively even environment, but also move in a relatively complex terrain environment, thereby improving the adaptability of the robot in different motion environments.

A device of controlling motion of a robot according to an embodiment of the present disclosure is described below with reference to FIG. 4. FIG. 4 is a schematic block diagram of the device of controlling motion of the robot according to an embodiment of the present disclosure. The robot in the present disclosure is the wheel-foot composite robot shown in FIG. 1, and the wheel-foot composite robot includes at least one environment sensing sensor.

As shown in FIG. 4, the device 500 of controlling motion of the robot includes: an information acquiring module 510, a mode determining module 520, and a motion controlling module 530.

Wherein the information acquiring module 510 is configured to control the environmental sensing sensor to acquire surrounding environmental information;

the modal determining module 520 is configured to determine a target motion mode of the wheel-foot composite robot based on the surrounding environmental information; and
the motion controlling module 530 is configured to control the motion of the wheel-foot composite robot based on the target motion mode.

In an optional implementation of the embodiments of the present disclosure, the target motion mode includes one of a wheeled motion mode and a wheel-foot composite motion mode.

In an optional implementation of the embodiments of the present disclosure, the mode determining module 520 includes:
a first determining unit configured to determine a state of an intended motion region of the wheel-foot composite robot based on the surrounding environmental information;
a second determining unit configured to determine that the target motion mode of the wheel-foot composite robot is a wheeled motion mode in response to the state of the intended motion region being even terrain and free of obstacles, and determine that the target motion mode of the wheel-foot composite robot is a wheel-foot composite motion mode in response to the state of the intended motion region being uneven terrain and/or presence of an obstacle.

In an optional implementation of the embodiments of the present disclosure, the wheel-foot composite robot further includes four motion mechanisms, the four motion mechanisms include two rear rollers and two front leg mechanisms, and an end of each of the front leg mechanisms is provided with a roller;
correspondingly, the wheel-foot composite motion mode includes:
based on wheeled motions of the two rear rollers, a foot type motion of a left front leg mechanism, and a wheeled motion of a right front leg mechanism, obtaining a first wheel-foot composite motion mode; or
based on wheeled motions of the two rear rollers, a wheeled motion of a left front leg mechanism, and a foot type motion of a right front leg mechanism, obtaining a second wheel-foot composite motion mode; or
based on wheeled motions of the two rear rollers and foot type motions of the two front leg mechanisms, obtaining a third wheel-foot composite motion mode.

In an optional implementation of the embodiments of the present disclosure, the device 500 further includes:
a task determining module configured to determine a to-be-executed motion task of the wheel-foot composite robot;
a mode determining module 520, which is specifically configured to determine a target motion mode of the wheel-foot composite robot based on the surrounding environmental information and the to-be-executed motion task.

In an optional implementation of the embodiments of the present disclosure, the mode determining module 520 is further configured to:
in response to determining that the state of the intended motion region of the wheel-foot composite robot is even terrain and free of obstacles based on the surrounding environmental information, and the to-be-executed motion task being a motion task, determining that the target motion mode of the wheel-foot composite robot is the wheeled motion mode;
in response to determining that the state of the intended motion region of the wheel-foot composite robot is uneven terrain and/or presence of an obstacle based on the surrounding environmental information, and the to-be-executed motion task being a motion task, determining that the target motion mode of the wheel-foot composite robot is the first wheel-foot composite motion mode, the second wheel-foot composite motion mode, or the third wheel-foot composite motion mode; and
in response to determining that the state of the intended motion region of the wheel-foot composite robot is even terrain and free of obstacles, or uneven terrain and/or presence of an obstacle based on the surrounding environmental information, and the to-be-executed motion task being an interactive task, determining that the target motion mode of the wheel-foot composite robot is the third wheel-foot composite motion mode.

In an optional implementation of the embodiments of the present disclosure, the motion task includes one of a forward task, a backward task, or a steering task.

It should be understood that the device embodiment and the foregoing method embodiments may correspond to each other, and similar descriptions may refer to the method embodiments. To avoid repetition, details are not described herein again. Specifically, the device 500 shown in FIG. 4 may execute the method embodiment corresponding to FIG. 2, and the foregoing and other operations and/or functions of each of modules in the device 500 are respectively used to implement corresponding procedures in the methods in FIG. 2, which will not be repeated here for the sake of brevity.

The device 500 in the embodiments of the present disclosure is described above with reference to the accompanying drawings from the perspective of a functional module. It should be understood that the functional module may be implemented in a form of hardware, or may be implemented by using instructions in a form of software, or may be implemented by combining hardware and software modules. Specifically, steps in the method embodiment of the first aspect in the embodiments of the present disclosure may be completed by using an integrated logic circuit of hardware in a processor and/or instructions in a form of software, and the steps in the method according to the first aspect disclosed in conjunction with the embodiments of the present disclosure may be directly embodied as being executed and completed by a hardware decoding processor, or executed and completed by combining hardware and software modules in a decoding processor. Optionally, the software module may be located in a mature storage medium in the art such as a random access memory, a flash memory, a read-only memory, a programmable read-only memory, an electrically erasable programmable memory, a register, and the like. The storage medium is located in the memory, the processor reads information in the memory, and completes the steps in the foregoing method embodiments of the first aspect in combination with hardware of the storage medium.

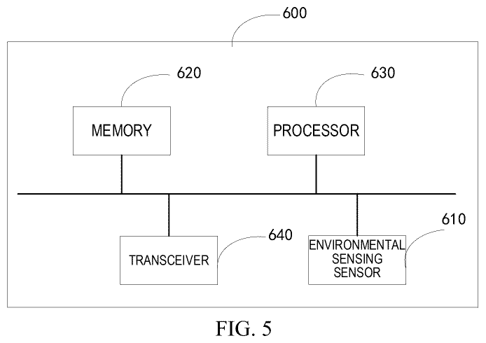

FIG. 5 is a schematic block diagram of a robot according to an embodiment of the present disclosure. The robot in the present disclosure is the wheel-foot composite robot shown in FIG. 1. As shown in FIG. 5, the robot 600 may include:
at least one environmental sensing sensor 610 configured to acquire surrounding environmental information of the robot; and
a memory 620 and a processor630, wherein the memory 620 is configured to store a computer program, and transmit a program code to the processor 630. In other words, the processor 630 may invoke and run the computer program from the memory 620, to execute the method of controlling motion of the robot in the embodiments of the present disclosure.

For example, the processor 630 may be configured to execute the above method of controlling motion of the robot based on instructions in the computer program.

In some embodiments of the present disclosure, the processor 630 may include, but is not limited to:
A general-purpose processor, a digital signal processor (DSP), an application specific integrated circuit (ASIC), a field programmable gate array (FPGA), or other programmable logic device, a discrete gate or transistor logic device, a discrete hardware component, or the like.

In some embodiments of the present disclosure, the memory 620 includes, but is not limited to:
Volatile memory and/or non-volatile memory. The non-volatile memory may be a read-only memory (ROM), a programmable read-only memory (Programmable PROM, PROM), an erasable programmable read-only memory (Erasable PROM, EPROM), an electrically erasable programmable read-only memory (Electrically EPROM, EEPROM), or a flash memory. The volatile memory may be a random access memory (RAM), which serves as an external cache. By way of example and not limitation, many forms of RAM are available, such as Static Random Access Memory (Static RAM, SRAM), Dynamic Random Access Memory (Dynamic RAM, DRAM), Synchronous Dynamic Random Access Memory (Synchronous SDRAM, SDRAM), Double Data Rate Synchronous Dynamic Random Access Memory (Double Data Rate SDRAM, DDR SDRAM), Enhanced Synchronous Dynamic Random Access Memory (Enhanced SDRAM, ESDRAM), Synch link Dynamic Random Access Memory (Synch link DRAM, SLDRAM), and Direct Rambus Random Access Memory (Direct Rambus RAM, DR RAM).

In some embodiments of the present disclosure, the computer program may be divided into one or more modules, and the one or more modules are stored in the memory 620 and executed by the processor 630 to complete the method of controlling motion of the robot provided in the present disclosure. The one or more modules may be a series of computer program instruction segments capable of completing a specific function, and the instruction segments are used to describe an execution process of the computer program in the robot.

As shown in FIG. 5, the robot 600 may further include:
a transceiver 640 that may be connected to the processor 630 or the memory 620.

The processor 630 may control the transceiver 640 to communicate with another device, specifically, may send information or data to other device, or receive information or data sent by other device. The transceiver 640 may include a transmitter and a receiver. The transceiver 640 may further include an antenna, the number of the antenna may be one or more.

It should be understood that each component in the robot is connected to the bus system, wherein the bus system includes, in addition to a data bus, a power bus, a control bus, and a status signal bus.

The present disclosure further provides a computer storage medium having a computer program stored thereon, the computer program, when executed by a computer, causing the computer to execute the method of controlling motion of the robot according to the foregoing method embodiments.

An embodiment of the present disclosure further provides a computer program product including program instructions, the program instructions, when running on a robot, causing the robot to perform the method of controlling motion of the robot according to the foregoing method embodiments.

When implemented using software, it may be implemented in whole or in part in the form of a computer program product. The computer program product includes one or more computer instructions. When the computer program instructions are loaded and executed on a computer, the processes or functions according to the embodiments of the present disclosure are all or partially generated. The computer may be a general-purpose computer, a special purpose computer, a computer network, or other programmable device. The computer instructions may be stored in a computer-readable storage medium or transmitted from one computer-readable storage medium to another computer-readable storage medium, for example, the computer instructions may be transmitted from a website site, a computer, a server, or a data center to another website site, computer, server, or data center over a wired (e.g., coaxial cable, optical fiber, digital subscriber line (DSL)) or wireless (e.g., infrared, wireless, microwave, etc.). The computer-readable storage medium may be any available medium that can be accessed by a computer or a data storage device such as a server or a data center, etc., that includes one or more available media integration. The usable medium may be a magnetic medium (for example, a floppy disk, a hard disk, a magnetic tape), an optical medium (for example, a digital video disc (DVD)), a semiconductor medium (for example, a solid state disk (SSD)), or the like.

Those of ordinary skill in the art will appreciate that the modules and algorithm steps of each example described in connection with the embodiments disclosed herein can be implemented in electronic hardware, or in combination of computer software and electronic hardware. Whether these functions are performed in hardware or software depends on the specific application and design constraints of the technical solutions. Those skilled in the art may use different methods for each particular application to implement the described functionality, but such implementations should not be considered to be beyond the scope of the present disclosure.

In the several embodiments provided in the present disclosure, it should be understood that the disclosed systems, devices, and methods may be implemented in other manners. For example, the device embodiments described above are merely illustrative, for example, the division of the modules is merely a logical function division, and in actual implementation, there may be another division manner, for example, multiple modules or components may be combined or may be integrated into another system, or some features may be ignored, or not executed. Alternatively, the mutual coupling or direct coupling or communication connection shown or discussed may be an indirect coupling or communication connection through some interfaces, devices, or modules, and may be in electrical, mechanical, or other forms.

The modules described as separate components may or may not be physically separate, and the components displayed as modules may or may not be physical modules, that is, may be located in one place, or may be distributed to multiple network units. Some or all of the modules may be selected according to actual needs to achieve the purpose of the solutions of the embodiments. For example, each functional module in the embodiments of the present disclosure may be integrated into one processing module, or may be separately physically present by each module, or may be integrated into one module by two or more modules.

In the embodiments of the present disclosure, the terms “module” or “unit” refer to a computer program or a part of a computer program having a predetermined function, and work together with other relevant parts to achieve a predetermined target, and may be implemented in whole or in part by using software, hardware (for example, a processing circuit or a memory), or a combination thereof. Similarly, a processor (or multiple processors or memories) may be used to implement one or more modules or units. Further, each module or unit may be part of an overall module or unit containing the module or unit function.

The foregoing descriptions are only specific implementations of the present disclosure, but the protection scope of the present disclosure is not limited thereto, and any person skilled in the art may easily conceive of changes or replacements within the technical scope of the present disclosure, and should be covered within the protection scope of the present disclosure. Therefore, the protection scope of the present disclosure should be based on the protection scope of the claims.

I/We claim:

1. A method of controlling motion of a robot, wherein the robot is a wheel-foot composite robot comprising at least one environmental sensing sensor, and the method comprises:
controlling the environmental sensing sensor to acquire surrounding environmental information;
determining a target motion mode of the wheel-foot composite robot based on the surrounding environmental information; and
controlling the motion of the wheel-foot composite robot based on the target motion mode.

2. The method of claim 1, wherein the target motion mode comprises one of a wheeled motion mode and a wheel-foot composite motion mode.

3. The method of claim 2, wherein the determining a target motion mode of the wheel-foot composite robot based on the surrounding environmental information comprises:
determining a state of an intended motion region of the wheel-foot composite robot based on the surrounding environmental information;
in response to the state of the intended motion region being even terrain and free of obstacles, determining that the target motion mode of the wheel-foot composite robot is a wheeled motion mode;
in response to the state of the intended motion region being uneven terrain and/or presence of an obstacle, determining that the target motion mode of the wheel-foot composite robot is a wheel-foot composite motion mode.

4. The method of claim 2, wherein the wheel-foot composite robot further comprises four motion mechanisms, the four motion mechanisms comprise two rear rollers and two front leg mechanisms, wherein an end of each of the front leg mechanisms is provided with a roller;
correspondingly, the wheel-foot composite motion mode comprises:
based on wheeled motions of the two rear rollers, a foot type motion of a left front leg mechanism, and a wheeled motion of a right front leg mechanism, obtaining a first wheel-foot composite motion mode; or
based on wheeled motions of the two rear rollers, a wheeled motion of a left front leg mechanism, and a foot type motion of a right front leg mechanism, obtaining a second wheel-foot composite motion mode; or
based on wheeled motions of the two rear rollers and foot type motions of the two front leg mechanisms, obtaining a third wheel-foot composite motion mode.

5. The method of claim 4, wherein the method further comprises:
determining a to-be-executed motion task of the wheel-foot composite robot;
determining a target motion mode of the wheel-foot composite robot based on the surrounding environmental information and the to-be-executed motion task.

6. The method of claim 5, wherein the determining a target motion mode of the wheel-foot composite robot based on the surrounding environmental information and the to-be-executed motion task comprises:
in response to determining that the state of the intended motion region of the wheel-foot composite robot is even terrain and free of obstacles based on the surrounding environmental information, and the to-be-executed motion task being a motion task, determining that the target motion mode of the wheel-foot composite robot is the wheeled motion mode;
in response to determining that the state of the intended motion region of the wheel-foot composite robot is uneven terrain and/or presence of an obstacle based on the surrounding environmental information, and the to-be-executed motion task being a motion task, determining that the target motion mode of the wheel-foot composite robot is the first wheel-foot composite motion mode, the second wheel-foot composite motion mode, or the third wheel-foot composite motion mode; and
in response to determining that the state of the intended motion region of the wheel-foot composite robot is even terrain and free of obstacles, or uneven terrain and/or presence of an obstacle, based on the surrounding environmental information, and the to-be-executed motion task being an interactive task, determining that the target motion mode of the wheel-foot composite robot is the third wheel-foot composite motion mode.

7. The method of claim 6, wherein the motion task comprises one of a forward task, a backward task, or a steering task.

8. A robot, comprising:
at least one environmental sensing sensor configured to acquire surrounding environmental information of the robot; and
a memory configured to store a computer program, and a processor configured to invoke and run the computer program stored in the memory, to execute a method of controlling motion of the robot, wherein the robot is a wheel-foot composite robot comprising at least one environmental sensing sensor, and the method comprises:
controlling the environmental sensing sensor to acquire surrounding environmental information;
determining a target motion mode of the wheel-foot composite robot based on the surrounding environmental information; and
controlling the motion of the wheel-foot composite robot based on the target motion mode.

9. The robot of claim 8, wherein the target motion mode comprises one of a wheeled motion mode and a wheel-foot composite motion mode.

10. The robot of claim 9, wherein the determining a target motion mode of the wheel-foot composite robot based on the surrounding environmental information comprises:
determining a state of an intended motion region of the wheel-foot composite robot based on the surrounding environmental information;
in response to the state of the intended motion region being even terrain and free of obstacles, determining that the target motion mode of the wheel-foot composite robot is a wheeled motion mode;
in response to the state of the intended motion region being uneven terrain and/or presence of an obstacle, determining that the target motion mode of the wheel-foot composite robot is a wheel-foot composite motion mode.

11. The robot of claim 9, wherein the wheel-foot composite robot further comprises four motion mechanisms, the four motion mechanisms comprise two rear rollers and two front leg mechanisms, wherein an end of each of the front leg mechanisms is provided with a roller;
correspondingly, the wheel-foot composite motion mode comprises:
based on wheeled motions of the two rear rollers, a foot type motion of a left front leg mechanism, and a wheeled motion of a right front leg mechanism, obtaining a first wheel-foot composite motion mode; or
based on wheeled motions of the two rear rollers, a wheeled motion of a left front leg mechanism, and a foot type motion of a right front leg mechanism, obtaining a second wheel-foot composite motion mode; or
based on wheeled motions of the two rear rollers and foot type motions of the two front leg mechanisms, obtaining a third wheel-foot composite motion mode.

12. The robot of claim 11, wherein the method further comprises:
determining a to-be-executed motion task of the wheel-foot composite robot;
determining a target motion mode of the wheel-foot composite robot based on the surrounding environmental information and the to-be-executed motion task.

13. The robot of claim 12, wherein the determining a target motion mode of the wheel-foot composite robot based on the surrounding environmental information and the to-be-executed motion task comprises:
in response to determining that the state of the intended motion region of the wheel-foot composite robot is even terrain and free of obstacles based on the surrounding environmental information, and the to-be-executed motion task being a motion task, determining that the target motion mode of the wheel-foot composite robot is the wheeled motion mode;
in response to determining that the state of the intended motion region of the wheel-foot composite robot is uneven terrain and/or presence of an obstacle based on the surrounding environmental information, and the to-be-executed motion task being a motion task, determining that the target motion mode of the wheel-foot composite robot is the first wheel-foot composite motion mode, the second wheel-foot composite motion mode, or the third wheel-foot composite motion mode; and
in response to determining that the state of the intended motion region of the wheel-foot composite robot is even terrain and free of obstacles, or uneven terrain and/or presence of an obstacle, based on the surrounding environmental information, and the to-be-executed motion task being an interactive task, determining that the target motion mode of the wheel-foot composite robot is the third wheel-foot composite motion mode.

14. The robot of claim 13, wherein the motion task comprises one of a forward task, a backward task, or a steering task.

15. A computer-readable storage medium configured to store a computer program, the computer program causing a computer to execute a method of controlling motion of a robot, wherein the robot is a wheel-foot composite robot comprising at least one environmental sensing sensor, and the method comprises:
controlling the environmental sensing sensor to acquire surrounding environmental information;
determining a target motion mode of the wheel-foot composite robot based on the surrounding environmental information; and
controlling the motion of the wheel-foot composite robot based on the target motion mode.

16. The computer-readable storage medium of claim 15, wherein the target motion mode comprises one of a wheeled motion mode and a wheel-foot composite motion mode.

17. The computer-readable storage medium of claim 16, wherein the determining a target motion mode of the wheel-foot composite robot based on the surrounding environmental information comprises:
determining a state of an intended motion region of the wheel-foot composite robot based on the surrounding environmental information;
in response to the state of the intended motion region being even terrain and free of obstacles, determining that the target motion mode of the wheel-foot composite robot is a wheeled motion mode;
in response to the state of the intended motion region being uneven terrain and/or presence of an obstacle, determining that the target motion mode of the wheel-foot composite robot is a wheel-foot composite motion mode.

18. The computer-readable storage medium of claim 16, wherein the wheel-foot composite robot further comprises four motion mechanisms, the four motion mechanisms comprise two rear rollers and two front leg mechanisms, wherein an end of each of the front leg mechanisms is provided with a roller;
correspondingly, the wheel-foot composite motion mode comprises:
based on wheeled motions of the two rear rollers, a foot type motion of a left front leg mechanism, and a wheeled motion of a right front leg mechanism, obtaining a first wheel-foot composite motion mode; or
based on wheeled motions of the two rear rollers, a wheeled motion of a left front leg mechanism, and a foot type motion of a right front leg mechanism, obtaining a second wheel-foot composite motion mode; or
based on wheeled motions of the two rear rollers and foot type motions of the two front leg mechanisms, obtaining a third wheel-foot composite motion mode.

19. The computer-readable storage medium of claim 18, wherein the method further comprises:
determining a to-be-executed motion task of the wheel-foot composite robot;
determining a target motion mode of the wheel-foot composite robot based on the surrounding environmental information and the to-be-executed motion task.

20. The computer-readable storage medium of claim 19, wherein the determining a target motion mode of the wheel-foot composite robot based on the surrounding environmental information and the to-be-executed motion task comprises:
in response to determining that the state of the intended motion region of the wheel-foot composite robot is even terrain and free of obstacles based on the surrounding environmental information, and the to-be-executed motion task being a motion task, determining that the target motion mode of the wheel-foot composite robot is the wheeled motion mode;
in response to determining that the state of the intended motion region of the wheel-foot composite robot is uneven terrain and/or presence of an obstacle based on the surrounding environmental information, and the to-be-executed motion task being a motion task, determining that the target motion mode of the wheel-foot composite robot is the first wheel-foot composite motion mode, the second wheel-foot composite motion mode, or the third wheel-foot composite motion mode; and
in response to determining that the state of the intended motion region of the wheel-foot composite robot is even terrain and free of obstacles, or uneven terrain and/or presence of an obstacle, based on the surrounding environmental information, and the to-be-executed motion task being an interactive task, determining that the target motion mode of the wheel-foot composite robot is the third wheel-foot composite motion mode.
